(19) United States
(12) Patent Application Publication
(10) Pub. No.: US 2014/0122159 A1
(43) Pub. Date: May 1, 2014

(54) License Meta-Model for Automatic License Reasoning

(71) Applicant: INTERNATIONAL BUSINESS MACHINES CORPORATION, Armonk, NY (US)

(72) Inventors: Hui Lei, Scarsdale, NY (US); Liangzhao Zeng, Mohegan Lake, NY (US)

(73) Assignee: INTERNATIONAL BUSINESS MACHINES CORPORATION, Armonk, NY (US)

(21) Appl. No.: 13/662,057

(22) Filed: Oct. 26, 2012

Related U.S. Application Data
(63) Continuation of application No. 13/661,718, filed on Oct. 26, 2012.

(51) Int. Cl. G06Q 10/06

(52) U.S. Cl. CPC G06Q 10/06315
USPC 705/7.25

(57) ABSTRACT

Techniques, a system and an article of manufacture for generating a license meta-model for automatic license reasoning include creating an object-oriented information model to describe a hardware infrastructure, a software deployment environment, and an organization structure corresponding to a software license deployment, creating a set of property functions to formulate one or more items of information related to the hardware infrastructure, one or more users, and the organization structure, creating a set of license metrics by defining license metric capacity unit and license metric capacity calculation logic that leverage at least one existing property function and/or at least one of the created property functions, and leveraging the license metrics to model the software license.

### CROSS-REFERENCE TO RELATED APPLICATIONS

This application is a continuation of U.S. patent application Ser. No. 13/661,718, filed Oct. 26, 2012, and incorporated by reference herein.

### FIELD OF THE INVENTION

Embodiments of the invention generally relate to information technology (IT), and, more particularly, to license management.

### BACKGROUND

Currently, software licenses are defined using plain text, in human readable format. For example, current license management systems use keywords to identify a license metric and a lack of formal, semantic description to reason license capability. Such a situation creates potential for error, as many manual efforts are required.

In general, a software license includes a collection of license metrics. Further, a license metric contains rich information, including expressive formulae and/or rules for capacity unit and capacity calculation. Also, high-level license metrics can be defined based on multiple basic license metrics. Therefore, in order to enable automatic reasoning, which includes but is not limited to software license requirement calculations, software license comparisons, import/export software license definition among different license management tools, etc., a need exists for a well-defined metamodel (that is, language) to specify a software license in order to provide automated license reasoning capable of handling complicated software licenses.

### SUMMARY

In one aspect of the present invention, techniques for generating license models based on license meta-mode for automatic license reasoning are provided. An exemplary computer-implemented method for modeling a software license using a metamodel can include steps of creating an object-oriented information model to describe a hardware infrastructure, a software deployment environment, and an organization structure corresponding to a software license deployment, creating a set of property functions to formulate one or more items of information related to the hardware infrastructure, one or more users, and the organization structure, creating a set of license metrics by defining license metric capacity unit and license metric capacity calculation logic that leverage at least one existing property function and/or at least one of the created property functions, and leveraging the license metrics to model the software license.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and operative to perform noted method steps. Yet further, another aspect of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram illustrating an example embodiment of the invention;

FIG. 2 is a flow diagram illustrating a technique for defining a license metric, according to an embodiment of the present invention;

FIG. 3 is a flow diagram illustrating a technique for creating a new software license, according to an embodiment of the present invention;

FIG. 4 is a flow diagram illustrating a technique for importing a license metric definition in other formats, according to an embodiment of the present invention;

FIG. 5 is flow diagram illustrating a technique for importing a software license definition in other formats, according to an embodiment of the present invention;

FIG. 6 is a diagram illustrating supporting interoperation among license management systems, according to an embodiment of the present invention;

FIG. 7A and FIG. 7B are diagrams illustrating supporting license metric analysis, according to an embodiment of the present invention;

FIG. 8A and FIG. 8B are diagrams illustrating supporting license metric comparison, according to an embodiment of the present invention;

FIG. 9 is a diagram illustrating supporting a license requirement calculation, according to an embodiment of the present invention;

FIG. 10 is a flow diagram illustrating a technique for returning a license requirement, according to an embodiment of the present invention;

FIG. 11 is a flow diagram illustrating techniques for modeling a software license using a metamodel, according to an embodiment of the invention; and

FIG. 12 is a system diagram of an exemplary computer system on which at least one embodiment of the invention can be implemented.

### DETAILED DESCRIPTION

As described herein, an aspect of the present invention includes a license metamodel that enables generating license models for automatic license reasoning. The license metamodel provides a formal language that enables semantic description of software licenses. When a software license is defined using the metamodel, it is not only human readable, but also machine (that is, computer system) understandable, which further enables automatic license reasoning.

As noted above, in general, a software license is defined by a collection of license metrics. Further, a license metric includes a license capacity unit definition and license capacity calculation logic, wherein both components can be defined by expressions and/or rules. Both expressions and rules are defined using software/hardware deployment and organization information. Also, a new license metric can be defined based on a collection of existing license metrics.

By understanding information required to define a software license, a metamodel can be created to facilitate determination of a formal definition of a software license. In at least one embodiment of the invention, the metamodel includes multiple layers of components; namely, IT Environment metamodel, Property Function metamodel, License Capacity Unit metamodel, License Capacity Calculation metamodel, License Metric metamodel and Software License model.

In such an embodiment, an extensible markup language (XML) schema is used to implement the software license metamodel. In the XML schema, the software license type is defined as:

<xs:complexType name=“SoftwareLicenseType”>

<xs:sequence>

<xs:element name=“LicenseMetric”
type=“lm:LicenseMetricType”

maxOccurs=“unbounded”/>

</xs:sequence>
<xs:attribute name=“LicenseID” type=“xs:string” use=“required”/>
<xs:attribute name=“CreationDate” type=“xs:date” use=“required”/>
<xs:attribute name=“Description” type=“xs:string”/>
<xs:attribute name=“LicenseName” type=“xs:string”/>
<xs:attribute name=“SerialNumber” type=“xs:string”/>
<xs:attribute name=“StartDate” type=“xs:date”/>
<xs:attribute name=“TerminateDate” type=“xs:date”/>

</xs:complexType>

A software license contains a set of LicenseMetric, which is further defined by LicenseMetricType as:

<xs:complexType name=“LicenseMetricType”>

<xs:sequence>

<xs:element name=“MetricIdentification”>

<xs:complexType>

<xs:attribute name=“metricName” type=“xs:string”

use=“required”/>

<xs:attribute name=“vendor” type=“xs:string”/>

</xs:complexType>

</xs:element>
<xs:choice>

<xs:sequence>

<xs:element name=“MetricDefinition”

type=“lm:MetricDefinitionType” maxOccurs=“unbounded”/>

</xs:sequence>
<xs:element name=“LicenseMetricReference”>

<xs:complexType>

<xs:attribute name=“refMetricName”
type=“xs:string”

use=“required”/>

</xs:complexType>

</xs:element>

</xs:choice>

</xs:sequence>

</xs:complexType>

A license metric includes Metriclndenfication, a collection of MetricDefinition or a LicenseMetricReference. Metriclndenfication contains information such as metric name or vendor to identify the license metric. LienseMetricReference refers to another license metric. Also, MetricDefinition is further defined by MetricDefintionType:

<xs:complexType name=“MetricDefinitionType”>

<xs:sequence>

<xs:element name=“DefaultScope”>

<xs:complexType>

<xs:complexContent>

<xs:extension base=“lm:MetricScopeType”>

<xs:attribute name=“postAggregation”

type=“xs:boolean” default=“true”/>

</xs:extension>

</xs:complexContent>

</xs:complexType>

</xs:element>
<xs:element name=“LicenseCapacityUnit”
maxOccurs=“unbounded”>

<xs:complexType>

<xs:complexContent>

<xs:extension base=“lm:PropertyFunctionType”/>

</xs:complexContent>

</xs:complexType>

</xs:element>
<xs:element name=“LicenseCapacityCalculation”
maxOccurs=“unbounded”>

<xs:complexType>

<xs:complexContent>

<xs:extension base=“lm:PropertyFunctionType”/>

</xs:complexContent>

</xs:complexType>

</xs:element>

</xs:sequence>

</xs:complexType>

A MetricDefinitionType includes defaultScope, a set of LicenseCapacityUnit and LicenseCapacityCalculation. The defaultScope is defined by extending MetricScopeType with Boolean attribute postAggregation, as follows:

```
<xs:element name=“DefaultScope”>
    <xs:complexType>
        <xs:complexContent>
            <xs:extension base=“lm:MetricScopeType”>
                <xs:attribute name=“postAggregation”
type=“xs:boolean” default=“true”/>
            </xs:extension>
        </xs:complexContent>
    </xs:complexType>
</xs:element>
```

MetricScopeType is further defined as:

```
<xs:complexType name=″MetricScopeType″>
  <xs:sequence>
    <xs:element name=″parentScope″ type=″Im:MetricScopeType″
    minOccurs=″0″/>
  </xs:sequence>
  <xs:attribute name=″scopeType″ type=″xs:string″ use=″required″/>
  <xs:attribute name=″scopeID″ type=″xs:string″ use=″required″/>
  <xs:attribute name=″scopeName″ type=″xs:string″ use=″required″/>
  <xs:attribute name=″scopeExprssion″ type=″xs:string″ use=″required″/>
</xs:complexType>
```

It should be noted that MetricScope may have one or no parent MetricScope, and includes attributes of scopeType, scopeID, scopeName and scopeExpression. It should also be noted that the default scope defines the scope that calculation logic to which both LicenseCapacityUnit and LicenseCapacityCalculation apply. In the case when calculation of a software license requirement's scope (that is, request scope) is bigger than the default scope, and when the postAggregation is true, then the LicenseCapacityUnit and LicenseCapacityCalculation is applied to all of the individual scopes (in default scope type) and the result is linearly aggregated to the request scope. If postAggregation is false, the LicenseCapacityUnit and LicenseCapacityCalculation are applied to the request scope.

Both LicenseCapacityUnit and LicenseCapacityCalculation are defined by PropertyFunctionType, which is further defined as:

```
<xs:complexType name=“PropertyFunctionType”>
    <xs:choice>
        <xs:element name=“FormulaBasedFunction”
type=“lm:FormulaBasedFunctionType”/>
        <xs:element name=“TableBasedFunction”
        type=“lm:TableBasedFunctionType”/>
        <xs:element name=“ExternalFunction”
        type=“lm:ExternalFunctionType”/>
        <xs:element name=“FunctionReference”>
            <xs:complexType>
                <xs:attribute name=“name” type=“xs:string”
                use=“required”/>
            </xs:complexType>
        </xs:element>
    </xs:choice>
</xs:complexType>
```

PropertyFunctionType can be either FormulaBasedFunctionType, TableBasedFunctionType, ExternalFunctionType, or FunctionReference. FormulaBasedFunctionType is defined as:

```
<xs:complexType name=“FormulaBasedFunctionType”>
    <xs:complexContent>
        <xs:extension base=“lm:FunctionType”>
            <xs:attribute name=“expression” type=“xs:string”
            use=“required”/>
        </xs:extension>
    </xs:complexContent>
</xs:complexType>
```

FormulaBasedFunctionType extends the definition of FunctionType with an attribute of expression. The FunctionType is defined as:

```
<xs:complexType name=“FunctionType”>
    <xs:attribute name=“functionID” type=“xs:string”/>
    <xs:attribute name=“name” type=“xs:string”/>
    <xs:attribute name=“isNumerical” type=“xs:boolean”
    use=“optional” default=“true”/>
    <xs:attribute name=“isScalar” type=“xs:boolean” default=“true”/>
    <xs:attribute name=“isFixedValue” type=“xs:boolean”
    use=“optional” default=“false”/>
</xs:complexType>
```

FunctionType includes attribute functionID that identifies the function, attribute name that represents the name of the function, attribute is Numerical that indicates whether the output of the function is numerical or not, attribute is Scalar that indicates whether the output of the function is vector or not, and attribute is FixedValue that indicates whether the output of the function is a fixed value or not. TableBasedFunctionType extends FunctionType, and includes a collection of Columns and a collection of Rows, defined as follows:

```
<xs:complexType name=“TableBasedFunctionType”>
    <xs:complexContent>
      <xs:extension base=“lm:FunctionType”>
          <xs:sequence>
              <xs:element name=“Columns” minOccurs=“0”>
                  <xs:complexType>
                      <xs:sequence>
                          <xs:element name=“Column”
type=“lm:ColumnType” maxOccurs=“unbounded”/>
                      </xs:sequence>
                  </xs:complexType>
              </xs:element>
              <xs:element name=“Rows”>
                <xs:complexType>
                  <xs:choice>
                      <xs:element name=“Row”
type=“lm:RowType” maxOccurs=“unbounded”/>
                  </xs:choice>
                  <xs:attribute name=“isMultipleResult”
type=“xs:boolean” use=“optional” default=“true”/>
                </xs:complexType>
              </xs:element>
          </xs:sequence>
      </xs:extension>
    </xs:complexContent>
</xs:complexType>
```

Column is defined by ColumnType, which is further defined as:

```
<xs:complexType name=“ColumnType”>
  <xs:complexContent>
    <xs:extension base=“lm:PropertyFunctionType”>
      <xs:attribute name=“columnName” type=“xs:string”
      use=“required”/>
    </xs:extension>
  </xs:complexContent>
</xs:complexType>
```

Row is defined by RowType, which is further defined as:

```
<xs:complexType name=“RowType”>
    <xs:sequence>
        <xs:element name=“Condition” minOccurs=“0”
        maxOccurs=“unbounded”>
            <xs:complexType>
                <xs:complexContent>
                    <xs:extension base=“lm:ConditionType”>
                        <xs:attribute name=“columnName”
type=“xs:string” use=“required”/>
                    </xs:extension>
                </xs:complexContent>
            </xs:complexType>
        </xs:element>
        <xs:element name=“Result” maxOccurs=“unbounded”>
            <xs:complexType>
                <xs:complexContent>
                    <xs:extension base=“lm:PropertyFunctionType”>
                        <xs:attribute name=“isReturnResult”
type=“xs:boolean” default=“true”/>
                    </xs:extension>
                </xs:complexContent>
            </xs:complexType>
        </xs:element>
    </xs:sequence>
</xs:complexType>
```

A RowType includes a collection of Conditions and a collection of Results. The condition is defined based on ConditionType with columnName, wherein ConditionType is further defined as:

```
<xs:complexType name=“ConditionType”>
    <xs:choice>
        <xs:element name=“PointCondition” type=“lm:ValueType”/>
        <xs:element name=“EnumerationCondition”
type=“lm:EnumerationConditionType”/>
        <xs:element name=“RangeCondition”
        type=“lm:RangeConditionType”/>
    </xs:choice>
</xs:complexType>
```

A ConditionType can be PointCondition, EnumerationCondition, or RangeCondition. A PointCondition is a ValueType, which is defined as:

```
<xs:complexType name=“ValueType”>
    <xs:attribute name=“displayable-value” type=“xs:string”/>
    <xs:attribute name=“internal-value” type=“xs:string”/>
</xs:complexType>
```

EnumerationCondition is defined as a set of ValueType, as follows:

```
<xs:complexType name=“EnumerationConditionType”>
    <xs:sequence>
        <xs:element name=“Enumeration” type=“lm:ValueType”
maxOccurs=“unbounded”/>
    </xs:sequence>
</xs:complexType>
```

RangeCondtion is defined by a LowerBound and UpperBound, as follows:

```
<xs:complexType name=“EnumerationConditionType”>
    <xs:sequence>
        <xs:element name=“Enumeration” type=“lm:ValueType”
maxOccurs=“unbounded”/>
    </xs:sequence>
</xs:complexType>
```

ExternalFunction is defined by ExternalFunctionType, which is further defined as:

```
<xs:complexType name=“ExternalFunctionType”>
    <xs:complexContent>
        <xs:extension base=“lm:FunctionType”>
            <xs:sequence>
                <xs:element name=“InputParameter” minOccurs=“0”
maxOccurs=“unbounded”>
                    <xs:complexType>
                        <xs:sequence>
                            <xs:element name=“ValueRetrieval”
type=“lm:PropertyFunctionType”/>
                        </xs:sequence>
                        <xs:attribute name=“name” type=“xs:string”
use=“required”/>
                    </xs:complexType>
                </xs:element>
            </xs:sequence>
            <xs:attribute name=“methodName” type=“xs:string”/>
            <xs:attribute name=“serviceURL” type=“xs:string”/>
            <xs:attribute name=“serviceType” type=“xs:string”/>
            <xs:attribute name=“serviceSpecificationURL”
            type=“xs:string”/>
        </xs:extension>
    </xs:complexContent>
</xs:complexType>
```

ExternalFunctionType allows specification of an external function such as a REST function, Web service, etc. There is an expression in the definition of FormulaBasedFunction and ScopeDefinition, the syntax of expression defined in JavaCC as:

```
SKIP:
{
  “ ”
| “\t”
| “\n”
| “\r”
| < “//” (~[ “\n”, “\r” ])*
    (
      “\n”
    | “\r”
    | “\r\n”
    ) >
| < “/*” (~[ “*” ])* “*”
    (
      ~[ “/” ] (~[ “*” ])* “*”
    )*
    “/” >
}
TOKEN : /* LITERALS */
{
  < INTEGER_LITERAL :
  < DECIMAL_LITERAL > ([ “1”, “L” ])?
  | < HEX_LITERAL > ([ “1”, “L” ])?
  | < OCTAL_LITERAL > ([ “1”, “L” ])?
    >
| < DECIMAL_LITERAL : ([ “1”-“9” ] ([ “0”-“9” ])*) |“0” >
| < #HEX_LITERAL : “0” [ “x”, “X” ] ([ “0”-“9”, “a”-“f”, “A”-“F” ])+ >
| < #OCTAL_LITERAL : “0” ([ “0”-“7” ])* >
}
TOKEN [IGNORE_CASE] : /* RESERVED WORDS */
{
  < THIS :“this” >
}
TOKEN [IGNORE_CASE] : /* BOOLEAN LITERALS */
{
  < TRUE: “true” >|< FALSE: “false” >
}
TOKEN : /* OPERATORS */
{
  < ADD: “+” >
|
  < MINUS: “−” >
|
  < MULTIPLY: “*” >
|
  < DIVIDE: “/” >
|
  < MODULAR: “%” >
|
  < UNION: “union” >
|
  <LPAREN: “(”>
|
  <RPAREN: “)”>
|
  < EQ: “==” >
|
  < NE: “!=” >
|
  < LT: “<” >
|
  < LE: “<=” >
|
  < GT: “>” >
|
  < GE: “>=” >
}
TOKEN [IGNORE_CASE]: /*logic operator */
{
< AND: “and” >|< OR: “or” >|< NOT: “not” >
}
TOKEN [IGNORE_CASE] : /* FUNCTIONS */
{
  < IF: “if” >
|
  < STRING_FUNCTION: “string” >
|
  < SUM: “sum” >
|
  < MAX: “max” >
|
  < MIN: “min” >
|
  < COUNT: “count” >
|
  < DISTINCTCOUNT: “DistinctCount” >
|
  < AVG: “avg” >
| < CONTAIN: “contain” >
}
TOKEN : /* IDENTIFIERS */
{
  < SCALAR_ENTITY: (< LETTER > ( < LETTER >| < DIGIT >)* (“(*)”)? ) >
|
  < QUOTED_STRING: “‘” (~[“‘”])+ “‘” >
|
  < #LETTER : [ “_”, “a”-“z”, “A”-“Z” ] >
|
  < #DIGIT : [ “0”-“9” ] >
}
/**
* Top level
*/
void parse( ):
{ }
{
    Expression( ) <EOF>
}
void Expression( ) :
{ }
{
  AdditiveExpression( )
}
void AdditiveExpression( ) :
{ }
{
  MultiplicativeExpression( )
  (
    (
      < ADD >
    | < MINUS>
    | < UNION >
    )
    MultiplicativeExpression( )
  )*
}
void MultiplicativeExpression( ) :
{ }
{
  UnaryExpression( )
  (
    (
      “*”
    | “/”
    | “%”
    )
      UnaryExpression( )
  )*
}
/*
* Unary Expression
*/
void UnaryExpression( ) :
{ }
{
Identity( )
| LOOKAHEAD(3)<LPAREN> Expression( )<RPAREN>
| FunctionExpression( )
}
/*
* Function Expression
*/
void FunctionExpression( ) :
{ }
  {
    < IF > <LPAREN> BooleanExpression( ) “,” UnaryExpression( ) “,”
UnaryExpression( ) <RPAREN>
    |
    <STRING_FUNCTION > <LPAREN> < QUOTED_STRING > <RPAREN>
    |
    LOOKAHEAD((< MIN > | < MAX > | < AVG >| <SUM > | <COUNT >|
<DISTINCTCOUNT >) <LPAREN> Identity( ) <RPAREN>) ColumnFunction( )
    |
    LOOKAHEAD((< MIN > | < MAX >) <LPAREN> Expression( ) “,” )
ScalarFunction( )
    | Integer( )
}
void ScalarFunction( ) :
{ }
{
    (< MIN > | < MAX >) <LPAREN> Expression( ) (“,”Expression( ) )+ <
RPAREN>
}
void ColumnFunction( ) :
{ }
{
    (< MIN > | < MAX > | < AVG >| <SUM >| <COUNT >| <DISTINCTCOUNT >)
<LPAREN> Identity( ) <RPAREN>
}
void BooleanExpression( ) :
{ }
{
    ORExpression( ) | NotExpression ( )
}
void NotExpression ( ) :
{ }
{
    < NOT > <LPAREN> ORExpression( ) <RPAREN>
}
void ORExpression( ):
{ }
{
    ANDExpression( ) (<OR> ANDExpression( ) ) *
}
void ANDExpression( ):
{ }
{
    ComparisonExpression( ) (< AND > ComparisonExpression( ) ) *
}
void ComparisonExpression( ) :
{ }
{
    < TRUE >
| < FALSE >
| <LPAREN> BooleanExpression( ) <RPAREN>
| LOOKAHEAD(Expression( ) ComparisonOperator( ) ) Expression( )
ComparisonOperator( ) Expression( )
| LOOKAHEAD(< CONTAIN > <LPAREN> ) < CONTAIN > <LPAREN>
Expression( )“,” Expression( ) <RPAREN>
}
void ComparisonOperator( ) :
{ }
{
  < EQ >|< NE >|< LT >|< LE >|< GT >|< GE >
}
void Identity( ) :
{ }
{
  LOOKAHEAD( < SCALAR_ENTITY > “( )”)
                < SCALAR_ENTITY > “( )”
| LOOKAHEAD( < SCALAR_ENTITY > “(”< SCALAR_ENTITY > “=” (“?” | <
QUOTED_STRING >| < INTEGER_LITERAL >) “)”)
                < SCALAR_ENTITY > “(”< SCALAR_ENTITY > “=” (“?” | <
QUOTED_STRING >| < INTEGER_LITERAL >) “)”
| LOOKAHEAD( < SCALAR_ENTITY > “(” <SCALAR_ENTITY > “=” (“?” | <
QUOTED_STRING >| < INTEGER_LITERAL >)
                (“,” < SCALAR_ENTITY > “=” (“?” | < QUOTED_STRING > | <
INTEGER_LITERAL >) )+ “)”)
            < SCALAR_ENTITY > “(” <SCALAR_ENTITY >“=”( “?” | <
QUOTED_STRING >| < INTEGER_LITERAL >)
                (“,” <SCALAR_ENTITY > “=” (“?”| < QUOTED_STRING > | <
INTEGER_LITERAL > ) ) +“)”
| ( < SCALAR_ENTITY > (Array( ))? ( LOOKAHEAD (“.” < SCALAR_ENTITY >
(Array( ))? “.”)
                                          (“.” < SCALAR_ENTITY >
(Array( ))? “.”)
                              | LOOKAHEAD (“.” < SCALAR_ENTITY >
“.”)
                                          (“.”) < SCALAR_ENTITY >
“.”)
                              | (“.” < SCALAR_ENTITY > ) )*
  )
| < THIS >“.” < SCALAR_ENTITY > (Array( ))? (“.” ( < SCALAR_ENTITY >
(Array( ))?)) *
}
void Array( ) :
{ }
{
“[ ]”
|LOOKAHEAD (2) (“[” (< SCALAR_ENTITY >“=” (“?”| < QUOTED_STRING >| <
INTEGER_LITERAL >))
                    (“,” (< SCALAR_ENTITY > “=” (“?” | < QUOTED_STRING
> | < INTEGER_LITERAL > )) )*“]”)
|LOOKAHEAD(3) (“[” < INTEGER_LITERAL >“]”)
|LOOKAHEAD(5) (“[”< INTEGER_LITERAL > “..”< INTEGER_LITERAL > “]”)
|LOOKAHEAD(4) (“[”“0..” < INTEGER_LITERAL > “]”)
}
void Integer( ) :
{ }
{
  < INTEGER_LITERAL >
}
```

The SCALAR_ENTITY in the syntax definition refers to objects defined in an IT environment, which can be defined by IT environment metamodel as the following XML Schema:

```
<xs:complexType name=“ITEnvironmentType”>
    <xs:sequence>
        <xs:element name=“ITEntities”>
            <xs:complexType>
                <xs:sequence>
                    <xs:element name=“ITEntity”
type=“lm:ITEntityType” maxOccurs=“unbounded”/>
                </xs:sequence>
            </xs:complexType>
        </xs:element>
        <xs:element name=“Organization”
        type=“lm:OrganizationType”/>
    </xs:sequence>
</xs:complexType>
```

The ITEntityType is further defined as:

```
<xs:complexType name=″ITEntityType″>
  <xs:sequence>
    <xs:element name=″Attributes″>
      <xs:complexType>
        <xs:sequence>
          <xs:element name=″Attribute″
maxOccurs=″unbounded″>
            <xs:complexType>
              <xs:complexContent>
                <xs:extension
base=″Im:ITEntityAttributeType″/>
              </xs:complexContent>
            </xs:complexType>
          </xs:element>
        </xs:sequence>
      </xs:complexType>
    </xs:element>
  </xs:sequence>
  <xs:attribute name=″entityName″ type=″xs:string″ use=″required″/>
  <xs:attribute name=″tableName″ type=″xs:string″/>
</xs:complexType>
```

In the definition, attribute entityName can be referred to by SCALAR_ENTITY, and attribute tableName indicates the table that persists the entity. There is a collection of attributes that is defined by ITEntityAttributeType, which is further defined as:

```
<xs:complexType name=“ITEntityAttributeType”>
    <xs: choice >
        <xs:element name=“AttributeMapping” minOccurs=“0”>
            <xs:complexType>
                <xs:attribute name=“columnName” type=“xs:string”
use=“required”/>
            </xs:complexType>
        </xs:element>
        <xs:element name=“AttributeLookup” minOccurs=“0”
        maxOccurs=“unbounded”>
            <xs:complexType>
                <xs:attribute name=“ForeignKey” type=“xs:string”/>
                <xs:attribute name=“ForeignTableName”
                type=“xs:string”/>
                <xs:attribute name=“PrimaryKey” type=“xs:string”/>
            </xs:complexType>
        </xs:element>
    </xs: choice >
    <xs:attribute name=“attributeName” type=“xs:string”/>
    <xs:attribute name=“attributeType” type=“xs:string”/>
    <xs:attribute name=“isID” type=“xs:boolean” default=“false”/>
    <xs:attribute name=“isArray” type=“xs:boolean” default=“false”/>
</xs:complexType>
```

ITEntityAttributeType has attributes including attributeName (name of the attribute), attributeType (data type of the attribute), is ID (whether the attribute is an ID for the entity) and is Array (whether the attribute is an array or not). ITEntityAttributeType may include AttributeMapping, which points to a column name of a table, or AttributeLookup, which specifies ForeignTableName, PrimaryKey and ForeignKey. In the case of AttributeLookup, the attribute itself is an object.

When license metrics and software licenses are formally defined using the above license metamodel, automatic license reasoning can be enabled. The automatic license reasoning includes, but is not limited to, automatic license requirement calculation, license metric analysis and comparison.

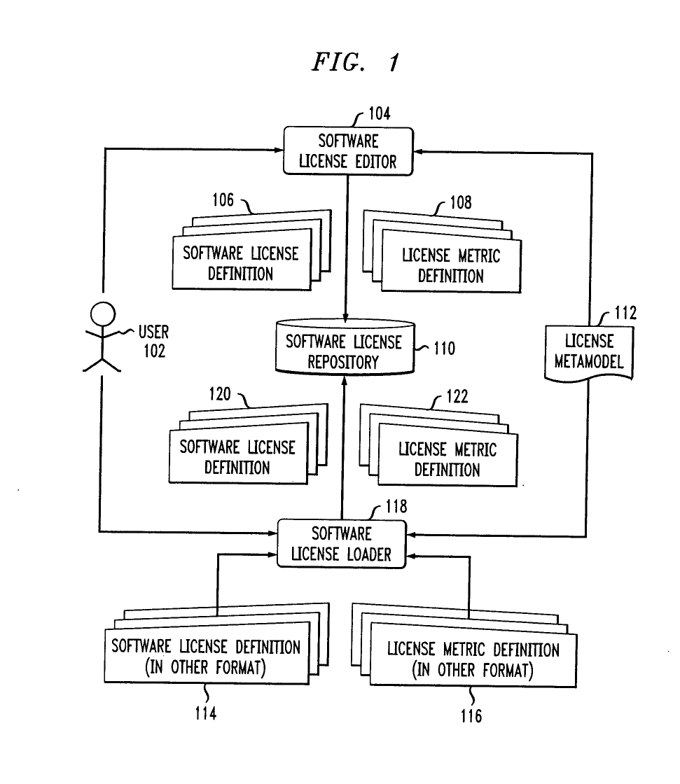

FIG. 1 is a block diagram illustrating an example embodiment of the invention. With a License Metamodel 112 defined in XML schema, a License Metric Editor module 104 and a License Metric Loader module 118 can be created. The License Metric Editor module 104 can create new software license definitions 106 and new license metric definitions 108. By way of example, with the Software License Loader module 118, users 102 can convert Software License Definitions 114 and License Metric Definitions 116 in other formats into Software License Definitions 120 and License Metric Definitions 122 in XML that conforms to the proposed License Metamodel 112 that is defined in XML schema. Both Software License Definitions (106 and 120) and License Metric Definitions (108 and 122) are persisted in a Software License Repository 110.

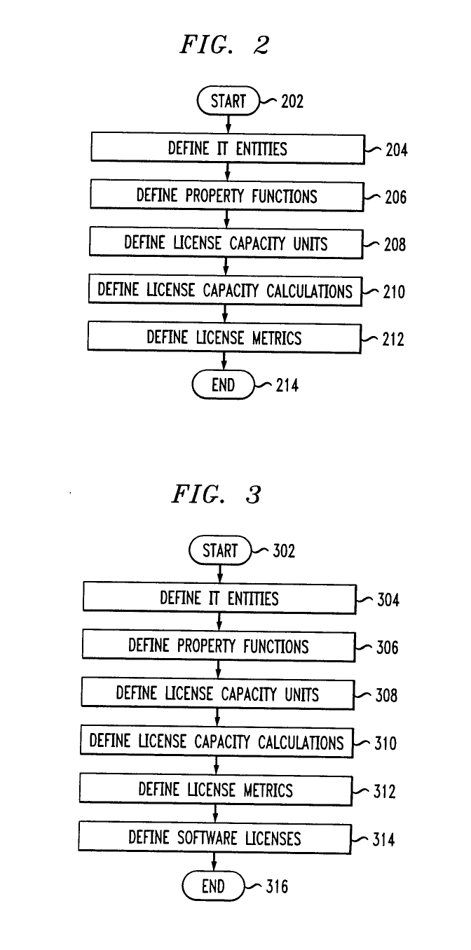

FIG. 2 is a flow diagram illustrating defining a license metric, according to an embodiment of the present invention. The process begins at step 202, and continues to step 204, which includes defining IT entities. Step 206 includes defining property functions, and step 208 includes defining license capacity units. Step 210 includes defining license capacity calculations, step 212 includes defining license metrics, and the process ends at step 214.

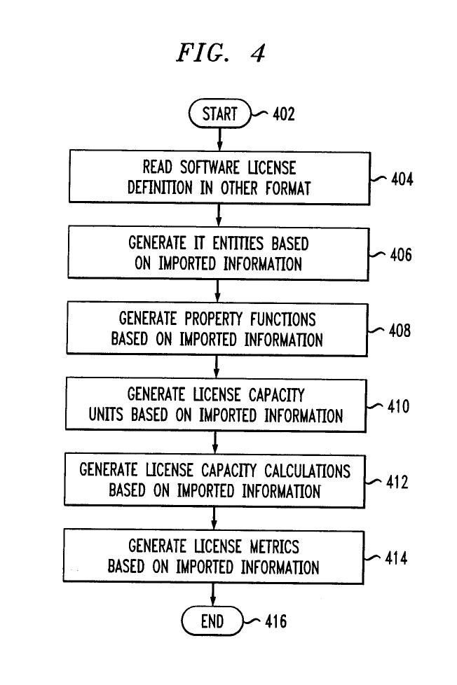

FIG. 3 is a flow diagram illustrating creating a new software license, according to an embodiment of the present invention. Similar to the flow shown in FIG. 2, the process begins at step 302, and continues to step 304, which includes defining IT entities. Step 306 includes defining property functions, and step 308 includes defining license capacity units. Step 310 includes defining license capacity calculations, and step 312 includes defining license metrics. Further, step 314 includes defining software licenses, and the process ends at step 316.

FIG. 4 is a flow diagram illustrating a technique for importing a license metric definition in other formats, according to an embodiment of the present invention. The process begins at step 402, and continues to step 404, which includes reading a software license definition in one of multiple formats. Step 406 includes generating IT entities based on imported information. Step 408 includes generating property functions based on imported information, and step 410 includes generating license capacity units based on imported information. Similarly, step 412 includes generating license capacity calculations based on imported information, step 414 includes generating license metrics based on imported information, and the process ends at step 416.

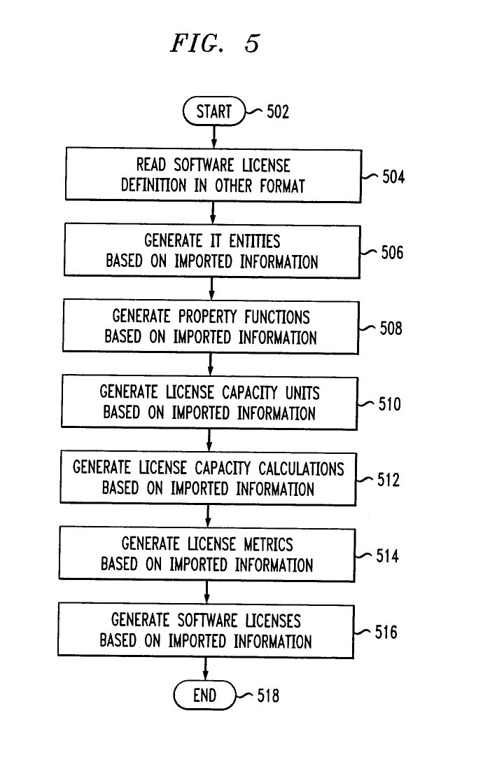

FIG. 5 is flow diagram illustrating a technique for importing a software license definition in other formats, according to an embodiment of the present invention. Similar to the flow shown in FIG. 4, the process begins at step 502, and continues to step 504, which includes reading a software license definition in one of multiple formats. Step 506 includes generating IT entities based on imported information. Step 508 includes generating property functions based on imported information, and step 510 includes generating license capacity units based on imported information. Step 512 includes generating license capacity calculations based on imported information, and step 514 includes generating license metrics based on imported information. Further, step 516 includes generating software licenses based on imported information, and the process ends at step 518.

In accordance with at least one embodiment of the invention, and as additionally described herein, an example of automatic license reasoning can be a license requirement calculation which answers the question of a software license requirement (a tuple, includes license capacity unit, license capacity) for giving software, license metric type and software deployment scope. For example, assuming a software (for instance, Websphere Application Server) is deployed on a server with 4 CPU and software license metric NumberOfCPU (that is, license is calculated as number of CPUs in the deployed host) is used to calculate license requirement, the software license calculation uses the definition of software license metric of NumberOfCPU, accesses the information about the number of CPU of the host that deploys the Websphere Application Server, and returns <4, CPU> as the result of license requirement.

License requirement calculations can include the following steps. Upon receiving a license requirement calculation request (software_ID, metric_type, req_scope, scope_ID) from a software asset manager, wherein software_ID indicates the type of software, metric_type is name of the license metric, req_scope represents software deployment scope, which can be a virtual machine, a physical server, cluster, data center, etc., a license metric of metric_type is retrieved.

Additionally, a default_scope in the metric definition is retrieved and a determination is made as to whether req_scope equals default_scope. If req_scope does equal default_scope, license capacity unit and license capacity are calculated, and a result of tuple<license capacity, license capacity unit> is generated and returned to the requester. If req_scope does not equal default_scope, an additional determination is made as to whether req_scope is smaller than min_scope. If req_scope is smaller than min_scope, a request error is generated and returned. If req_scope is not smaller than min_scope, all instances of default_scope in req_scope are retrieved, and a determination is made as to whether postAggregation is true. If postAggregation is not true, all of the instances are linearly aggregated, license capacity unit and license capacity are calculated, and a result is generated and returned.

If postAggregation is true, a determination is made as to whether capacity unit is a fixed value (that is, a string). If capacity unit is not a fixed value, license capacity unit and capacity unit are calculated in each instance in default_scope, all of the calculation results are linearly aggregated, and a result is generated and returned. If capacity unit is a fixed value, license capacity is calculated in each instance in default_scope, all of the calculation results are linearly aggregated, license capacity unit is calculated, and results are generated and returned.

In connection with at least one embodiment of the invention, a formula-based function for capacity unit and/or a formula-based function for capacity calculation can consider a multitude of variables and/or parameters. Such parameters can include users, memory (in megabytes (MB), for instance), number of processors, disks (in gigabytes (GB), for instance), value unit, nodes, concurrent user, servers, desktop, site, virtual array, management points, number of internet protocol (IP) addresses scanned, number of scans, connector, client license, per user client access license (CAL), per device CAL, physical central processing unit (CPU), processors managed by a product, per application instance, per establishment authorization, additional processors, per telephony port user, per mailbox user, number of logical partitions (LPARs), number of processors chips, etc.

Additionally, as described herein, usage of a software license meta-model includes supporting software license metric information inter-operation among multiple software license management systems. At least one embodiment of the invention can include exporting and/or importing license metric information in XML format (wherein an XML schema is defined by the software license meta-model) for a license information exchange. Usage of a software license metamodel also includes supporting software license metric analysis. For example, at least one embodiment of the invention includes exporting license metric information in an XML format, wherein XML documents provide a standard formation that allows further analysis, such as root cause analysis for license cost.

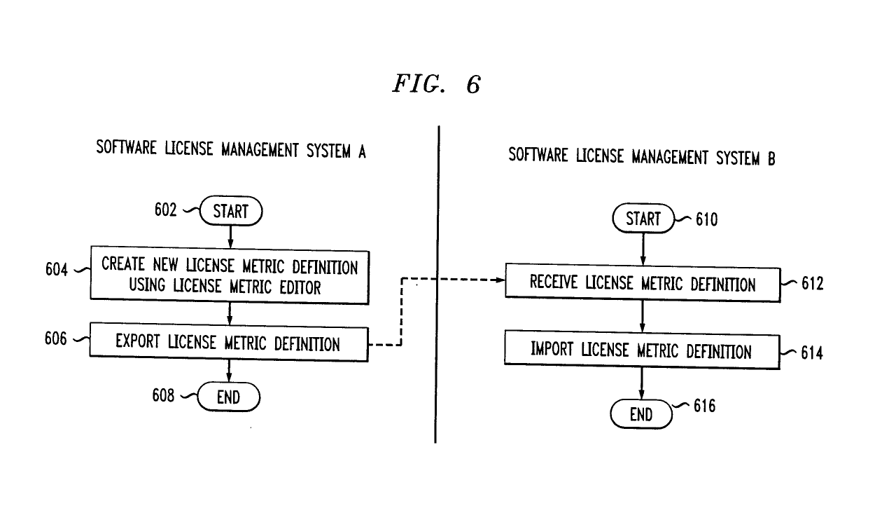

FIG. 6 is a diagram illustrating supporting interoperation among license management systems, according to an embodiment of the present invention. By way of illustration, FIG. 6 depicts an example sequence of steps for system license management system A, and an example sequence of steps for system license management system B. Namely, with respect to system license management system A, the sequence beings at step 602 and step 604 includes creating a new license metric definition using a license metric editor component. Step 606 includes exporting the license metric definition, and the sequence ends with step 608.

With respect to system license management system B, the sequence begins at step 610, and step 612 includes receiving a license metric definition (for example, receiving the license metric definition exported in step 606 from software license management system A). Step 614 includes importing the license metric definition, and the sequence ends with step 616.

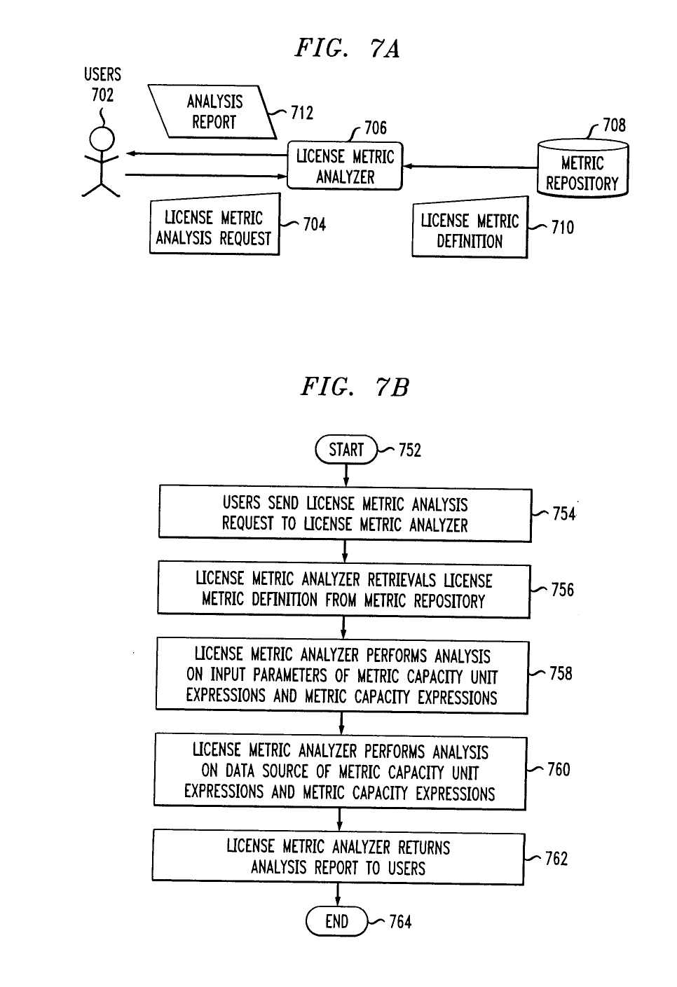

FIG. 7A and FIG. 7B are diagrams illustrating supporting license metric analysis, according to an embodiment of the present invention. FIG. 7A depicts users 702 making a license metric analysis request 704 to license metric analyzer component 706. The license metric analyzer component 706 obtains a license metric definition 710 from metric repository 708, and returns an analysis report 712 to users 702.

Similarly, as depicted in FIG. 7B, the process begins at step 752. Step 754 includes the user sending a license metric analysis request to the license metric analyzer. Step 756 includes the license metric analyzer retrieving a license metric definition from the metric repository. Step 758 includes the license metric analyzer performing analysis on input parameters of metric capacity unit expressions and metric capacity expressions. Step 760 includes the license metric analyzer performing analysis on a data source of metric capacity unit expressions and metric capacity expressions. Additionally, step 762 includes the license metric analyzer returning an analysis report to the users, and the process ends at step 764.

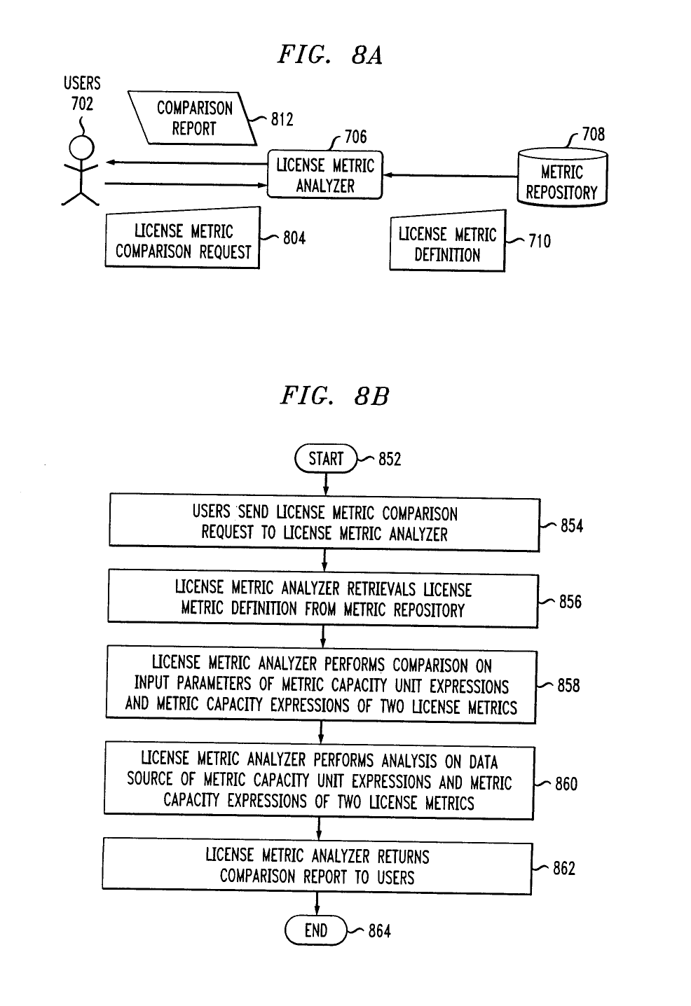

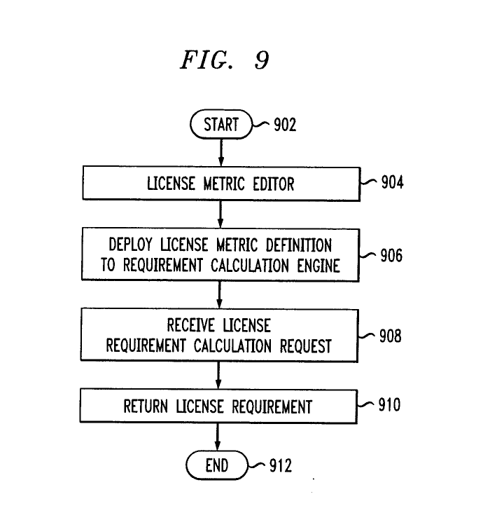

FIG. 8A and FIG. 8B are diagrams illustrating supporting license metric comparison, according to an embodiment of the present invention. FIG. 8A depicts users 702 making a license metric comparison request 804 to license metric analyzer component 706. The license metric analyzer component 706 obtains a license metric definition 710 from metric repository 708, and returns an analysis report 812 to users 702.

Similarly, as depicted in FIG. 7B, the flow diagram begins at step 852. Step 854 includes the users sending a license metric comparison request to the license metric analyzer. Step 856 includes the license metric analyzer retrieving license metric definitions from the metric repository. Step 858 includes the license metric analyzer performing a comparison on input parameters of metric capacity unit expressions and metric capacity expressions of two license metrics. Step 860 includes the license metric analyzer performing analysis on a data source of metric capacity unit expressions and metric capacity expressions of two license metrics. Additionally, step 862 includes the license metric analyzer returning a comparison report to the users, and the process ends at step 864.

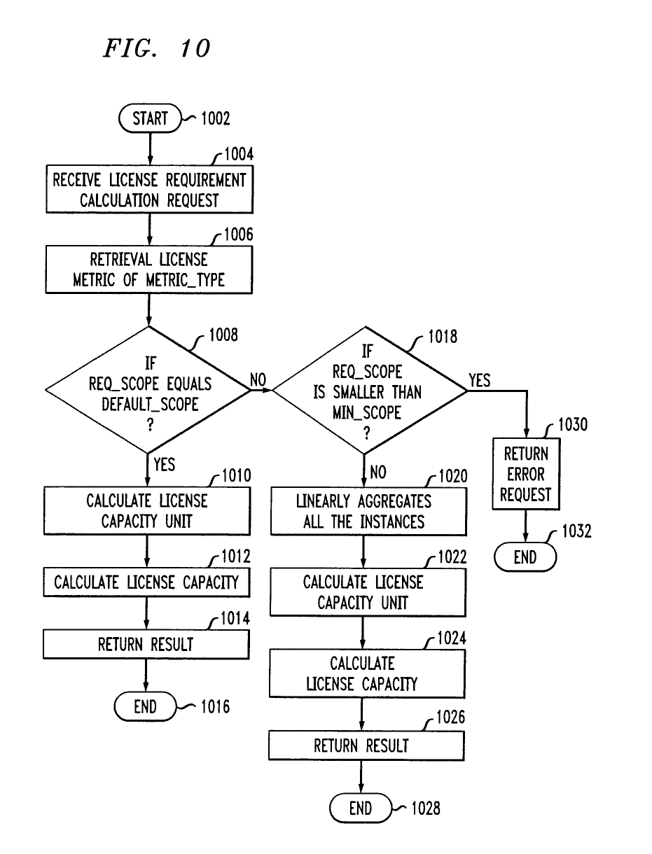

FIG. 9 is a flow diagram illustrating supporting a license requirement calculation, according to an embodiment of the present invention. The flow begins with step 902, and step 904 includes engaging a license metric editor to create a new license metric definition. Step 906 includes deploying the license metric definition to the requirement calculation engine/component (such as detailed herein). Step 908 includes receiving a license requirement calculation request, step 910 includes returning a license requirement, and the flow ends with step 912.

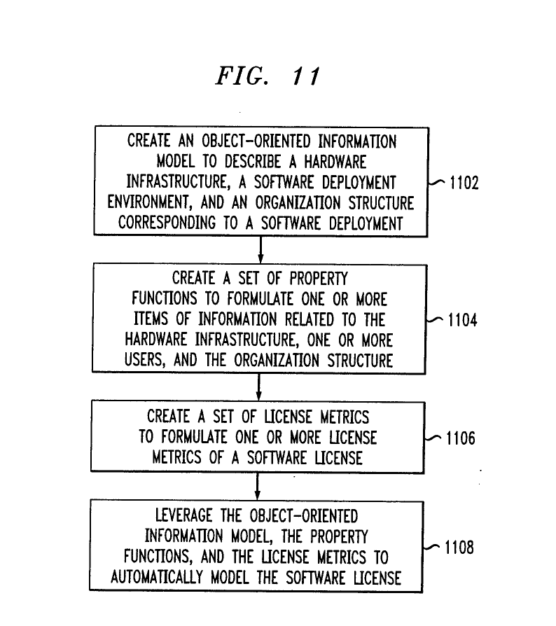

FIG. 10 is a flow diagram illustrating a technique for returning a license requirement, according to an embodiment of the present invention. The process begins at step 1002, and continues to step 1004, which includes receiving a license requirement calculation request. Step 1006 includes retrieving the license metric of metric_type, and step 1008 includes determining whether req_scope equals default_scope. If yes (that is, req_scope equals default_scope), then the process continues to step 1010, which includes calculating a license capacity unit. Additionally, step 1012 includes calculating license capacity, step 1014 includes returning the result, and the process ends at step 1016.

If req_scope does not equal default_scope in step 1008, the process continues onto step 1018, which includes determining whether req_scope is smaller than min_scope. If no (that is, req_scope is larger than min_scope), then the process continues onto step 1020, which includes linearly aggregating all of the instances. Further, step 1022 includes calculating a license capacity unit, step 1024 includes calculating license capacity, step 1026 includes returning the result, and the process ends at step 1028. If req_scope is smaller than min_scope in step 1018, an error request is returned in step 1030, and the process ends at step 1032.

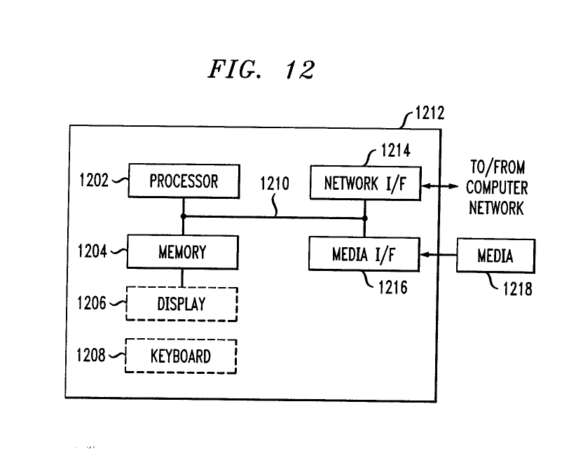

FIG. 11 is a flow diagram illustrating techniques for modeling a software license using a metamodel, according to an embodiment of the present invention. Step 1102 includes creating an object-oriented information model to describe a hardware infrastructure, a software deployment environment, and an organization structure corresponding to a software license deployment. Creating an object-oriented information model includes identifying a collection of entity classes that describe the hardware infrastructure and the software deployment environment corresponding to the software license. Additionally, creating an object-oriented information model includes identifying a data source for retrieving IT environment information, identifying a collection of organizations that utilize the software license, and identifying a collection of organizations that utilize the software license.

Step 1104 includes creating a set of property functions to formulate one or more items of information related to the hardware infrastructure, one or more users, and the organization structure. As described herein, a property function is used to define a license capacity unit and/or a license capacity calculation. Additionally, creating a set of property functions can include identifying a collection of schema that defines the one or more property functions of the software license. The property functions can include a formula-based function, a table-based function, a generic function with input and output specification, and/or a reference to another function.

Step 1106 includes creating a set of license metrics by defining license metric capacity unit and license metric capacity calculation logic that leverage at least one existing property function and/or at least one of the created property functions. Creating a set of license metrics can include generating a schema that defines a license metric by name, by license capacity unit, and/or by license capacity calculation logic. Also, creating a set of license metrics can include generating a schema that defines a new license metric based on existing license metrics using a formula-based function, a table-based function, and/or a generic function with input and output specification.

Step 1108 includes leveraging the license metrics to model the software license. Also, the techniques depicted in FIG. 11 can additionally include enabling interoperation among multiple software license management systems. This can include, for example, modeling a software license metric to generate a corresponding license metric definition that conforms to the a set of license metrics, exporting the corresponding license metric definition in a formally defined (for example, XML) format, and importing a license metric definition in a formally defined (for example, XML) format from a separate software license management system.

Further, the techniques depicted in FIG. 11 can also include performing model analysis of the one or more license metrics of the software license. This can include, for example, performing a model analysis on the one or more license metrics of the software license that are formally defined.

As also detailed herein, at least one embodiment of the invention includes automatically reasoning software license metrics. Such an embodiment includes providing a software license model editor for creating a software license metric definition using a software license metamodel and/or providing a software license loader for importing a software license metric definition in one of multiple formats to create a software license metric definition using software license metamodel, wherein the software license metric definition specifies identification of software license metric, capacity unit and capacity calculation. Additionally, such an embodiment includes deploying the software license metric definition, and receiving license requirement calculation request for a deployed software and returning the actual license requirement for the deployed software. Further such an embodiment includes receiving a software license metric analysis request for a software license and returning one or more expressions for license capacity unit and a license capacity calculation, a default scope of license capacity unit, one or more input parameters for expression of license capacity unit and/or license capacity calculation. Additionally, such an embodiment includes receiving a software license metric comparison request for two or more software license metric definitions and returning a differentiation between default scopes corresponding to the two or more software license metric definitions, one or more expressions in capacity unit and/or capacity calculation, and one or more input parameters of the expressions.

Further, as additionally detailed herein, at least one embodiment of the invention includes enabling interoperation between two software license management systems. Such an embodiment includes providing a software license model editor for creating a software license metric definition using a software license metamodel, exporting the software license metric definition in a format that conforms to the software license metamodel, and importing the software license metric definition in the format that conforms with the software license metamodel and deploying the software license metric definition.

The techniques depicted in FIG. 11 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an aspect of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 11 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code is downloaded over a network to a remote data processing system for use in a computer readable storage medium with the remote system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in a computer readable medium having computer readable program code embodied thereon.

An aspect of the invention or elements thereof can be implemented in the form of an apparatus including a memory and at least one processor that is coupled to the memory and operative to perform exemplary method steps.

Additionally, an aspect of the present invention can make use of software running on a general purpose computer or workstation. With reference to FIG. 12, such an implementation might employ, for example, a processor 1202, a memory 1204, and an input/output interface formed, for example, by a display 1206 and a keyboard 1208. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 1202, memory 1204, and input/output interface such as display 1206 and keyboard 1208 can be interconnected, for example, via bus 1210 as part of a data processing unit 1212. Suitable interconnections, for example via bus 1210, can also be provided to a network interface 1214, such as a network card, which can be provided to interface with a computer network, and to a media interface 1216, such as a diskette or CD-ROM drive, which can be provided to interface with media 1218.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 1202 coupled directly or indirectly to memory elements 1204 through a system bus 1210. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 1208, displays 1206, pointing devices, and the like) can be coupled to the system either directly (such as via bus 1210) or through intervening I/O controllers (omitted for clarity).

Network adapters such as network interface 1214 may also be coupled to the system to enable the data processing system to become coupled to other data processing systems or remote printers or storage devices through intervening non-public or public networks. Modems, cable modem and Ethernet cards are just a few of the currently available types of network adapters.

As used herein, including the claims, a “server” includes a physical data processing system (for example, system 1212 as shown in FIG. 12) running a server program. It will be understood that such a physical server may or may not include a display and keyboard.

As noted, aspects of the present invention may take the form of a computer program product embodied in a computer readable medium having computer readable program code embodied thereon. Also, any combination of computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the present invention may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, to partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. Accordingly, an aspect of the invention includes an article of manufacture tangibly embodying computer readable instructions which, when implemented, cause a computer to carry out a plurality of method steps as described herein.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, component, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 1202. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed.

At least one aspect of the present invention may provide a beneficial effect such as, for example, facilitating automatic software license requirement calculation.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. An article of manufacture comprising a computer readable storage medium having computer readable instructions tangibly embodied thereon which, when implemented, cause a computer to carry out a plurality of method steps comprising:
creating an object-oriented information model to describe a hardware infrastructure, a software deployment environment, and an organization structure corresponding to a software license deployment;
creating a set of property functions to formulate one or more items of information related to the hardware infrastructure, one or more users, and the organization structure;
creating a set of license metrics, wherein each of the license metrics comprises (i) license metric capacity unit logic and (ii) license metric capacity calculation logic that are each defined by one or more mathematical expressions that leverage at least one existing property function and the created set of property functions; and
leveraging the license metrics to model the software license.

2. The article of manufacture of claim 1, wherein creating an object-oriented information model comprises identifying a collection of entity classes that describe the hardware infrastructure and the software deployment environment corresponding to the software license.

3. The article of manufacture of claim 1, wherein creating an object-oriented information model comprises identifying a data source for retrieving information technology environment information.

4. The article of manufacture of claim 1, wherein creating an object-oriented information model comprises identifying a collection of organizations that utilize the software license.

5. The article of manufacture of claim 1, wherein the set of property functions is used to define a license capacity unit and/or a license capacity calculation.

6. The article of manufacture of claim 1, wherein creating a set of property functions comprises identifying a collection of schema that defines the one or more property functions of the software license.

7. The article of manufacture of claim 1, wherein the set of property functions comprises a formula-based function.

8. The article of manufacture of claim 1, wherein the set of property functions comprises a table-based function.

9. The article of manufacture of claim 1, wherein the set of property functions comprises a function with input and output specification.

10. The article of manufacture of claim 1, wherein the set of property functions comprises a reference to another function.

11. The article of manufacture of claim 1, wherein creating a set of license metrics comprises generating a schema that defines a license metric by name.

12. The article of manufacture of claim 1, wherein creating a set of license metrics comprises generating a schema that defines a license metric by license capacity unit.

13. The article of manufacture of claim 1, wherein creating a set of license metrics comprises generating a schema that defines a license metric by license capacity calculation logic.

14. The article of manufacture of claim 1, wherein creating a set of license metrics comprises generating a schema that defines at least one new license metric based on existing license metrics using a formula-based function, a table-based function, and/or a generic function with input and output specification.

15. The article of manufacture of claim 1, wherein the method steps comprise:
enabling interoperation among multiple software license management systems, wherein said enabling comprises modeling at least one software license metric to generate at least one corresponding license metric definition that conforms to the set of license metrics.

16. The article of manufacture of claim 15, wherein the method steps comprise:
exporting the at least one corresponding license metric definition in a formally defined format.

17. The article of manufacture of claim 15, wherein the method steps comprise:
importing a license metric definition in a formally defined format from a separate software license management system.

18. The article of manufacture of claim 1, wherein the method steps comprise:
performing model analysis of the one or more license metrics of the software license, wherein said performing comprises performing a model analysis on the one or more license metrics of the software license that are formally defined.

19. A system for modeling a software license using a metamodel, comprising:
at least one distinct software module, each distinct software module being embodied on a tangible computer-readable medium;
a memory; and
at least one processor coupled to the memory and operative for:
creating an object-oriented information model to describe a hardware infrastructure, a software deployment environment, and an organization structure corresponding to a software license deployment;
creating a set of property functions to formulate one or more items of information related to the hardware infrastructure, one or more users, and the organization structure;
creating a set of license metrics, wherein each of the license metrics comprises (i) license metric capacity unit logic and (ii) license metric capacity calculation logic that are each defined by one or more mathematical expressions that leverage at least one existing property function and the created set of property functions; and
leveraging the license metrics to model the software license.

20. An article of manufacture comprising a computer readable storage medium having computer readable instructions tangibly embodied thereon which, when implemented, cause a computer to carry out a plurality of method steps comprising:
providing a software license model editor for creating a software license metric definition using a software license metamodel and/or providing a software license loader for importing a software license metric definition in one of multiple formats to create a software license metric definition using software license metamodel, wherein the software license metric definition specifies identification of software license metric, capacity unit logic and capacity calculation logic each defined by one or more mathematical expressions that leverage at least one property function that formulates one or more items of information related to hardware infrastructure, one or more users, and organization structure corresponding to a software license deployment;
deploying the software license metric definition;
receiving license requirement calculation request for a deployed software and returning a license requirement for the deployed software;
receiving a software license metric analysis request for a software license and returning one or more expressions for license capacity unit and a license capacity calculation, a default scope of license capacity unit, one or more input parameters for expression of license capacity unit and/or license capacity calculation; and
receiving a software license metric comparison request for two or more software license metric definitions and returning a differentiation between default scopes corresponding to the two or more software license metric definitions, one or more expressions in capacity unit and/or capacity calculation, and one or more input parameters of the expressions.
